(19) United States
(12) Patent Application Publication
(10) Pub. No.: US 2023/0059115 A1
(43) Pub. Date: Feb. 23, 2023

(54) MACHINE LEARNING TECHNIQUES TO OPTIMIZE USER INTERFACE TEMPLATE SELECTION

(71) Applicant: Microsoft Technology Licensing, LLC, Redmond, WA (US)

(72) Inventors: Jinyun YAN, San Jose, CA (US); Vinay Praneeth BODA, Mountain View, CA (US); Mingyang HU, Sunnyvale, CA (US); Randell C. COTTA, San Mateo, CA (US); Scott SERRANO, San Jose, CA (US); Keren Kochava BARUCH, Sunnyvale, CA (US); Tomas CHAVARRIA, Palo Alto, CA (US); Grant EMPEY, Sunnyvale, CA (US); James HUNG, Sunnyvale, CA (US)

(21) Appl. No.: 17/406,443

(22) Filed: Aug. 19, 2021

(51) Int. Cl. G06F 11/34; G06N 20/00; G06F 9/451

(52) U.S. Cl. CPC G06F 11/3428; G06N 20/00; G06F 9/451

(57) ABSTRACT

Machine learning techniques to optimize user interface template selection are provided. In one technique, a first set of feature values pertaining to a first entity is identified. Multiple sets of feature values are also identified, each set of feature values pertaining to a different user interface (UI) template for rendering content items on a computer screen. For each set of feature values of the multiple sets, the set of feature values and the first set of feature values are inserted into a machine-learned model to generate a score, which is added to a set of scores, which set of scores is initially empty. Based on the set of scores, a particular UI template is selected for a content item. The content item is transmitted over a computer network to be presented on a screen of a computing device of the first entity according to the particular UI template.

### TECHNICAL FIELD

The present disclosure relates to machine learning and, more particularly, to optimizing user interface template selection using machine learning techniques.

### BACKGROUND

Content delivery platforms include mechanisms for receiving content items from content providers and presenting those content items to users who visit the content delivery platforms or affiliated computer systems. Content delivery platforms typically provide an interface for accepting information about the content of content items and presenting those content items in a particular format. For example, a content item includes a title, a logo, an image, a text description, and a call-to-action button. A format for all content items on a content delivery platform may be that the title is placed at the top of the content item, the image is placed below the title, the text description is placed below the image, and the call-to-action button is placed at the bottom of the content item. There may be tens or hundreds of formatting attributes in addition to what items within a content item to display, an arrangement of those items, and other visual characteristics for rendering a content item. Each set of visual characteristics (e.g., formatting attributes) that describes how a content item is to be rendered on a screen of a computing device is referred to as a user interface (UI) template.

The UI template that is used to render content items may have a significant effect on user interactions with the content items and/or with the content delivery platform itself. For example, content items that include four lines of text description may result in longer user sessions than user sessions that result when content items that include two lines of text description are presented. As another example, content items that include a call-to-action (CTA) button of one size may result in more user selections than content items that include a CTA button of another size. As another example, content items with a certain combination of colors may result in more conversions than content items with other combinations of colors.

In order to determine which UI template performs best, a test engineer may set up an A/B test that tests two different UI templates. Thus, 90% of user traffic for a particular time period (e.g., a particular day) will be presented with content items that are formatted according to one UI template and 10% of that user traffic will be presented with content items that are formatted according to another UI template.

There are a number of drawbacks to this A/B testing approach. First, A/B testing requires a significant amount of manual input to not only set up the A/B test, but also to interpret the results to determine whether the results are statistically significant. Second, A/B testing does not scale well when the number of possible UI templates is large, such as in the hundreds or thousands. As the number of UI templates increases, the search space grows exponentially. Third, A/B testing does not take into account contextual features. For example, the most engaging UI template on desktop and on mobile might be different. Fourth, A/B testing does not take into account user features. For example, the most engaging UI template for users from the information technology industry may be different than the most engaging UI template for users from the automotive industry. Fifth, once a A/B test is complete, the UI template(s) that did not perform sufficiently well will not be used again in rendering content items in the future, unless the UI template is made part of another A/B test. Thus, even though a suboptimal UI template that is discovered through an A/B test might become optimal at a later time, that previous suboptimal UI template will not be tested again unless another A/B test is designed and run for that UI template.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram that depicts an example system that processes a content item request that is initiated by a client device, in an embodiment;

FIG. 3 is a screenshot of an example content item that comprises multiple components, in an embodiment;

FIG. 4 is a flow diagram that depicts an example process for rendering one or more content items, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for using machine learning to optimize UI template selection are provided. In one technique, a machine-learned model is trained using one or more machine learning techniques. Features of the machine-learned model include features of each candidate UI template and features of an entity that will be presented with a content item and/or features of the context in which the content item will be presented. The machine-learned model is invoked for each candidate UI template to generate a score. The candidate UI template that is associated with the highest score may be selected for rendering the content item on a screen of a computing device of the entity.

Embodiments improve computer-related technology pertaining to UI template selection by avoiding the disadvantages associated with AB testing, such as manual setup and non-scalability. Also, embodiments improve UI template selection by taking into account context and personalization, resulting in more accurate real-time models.

### System Overview

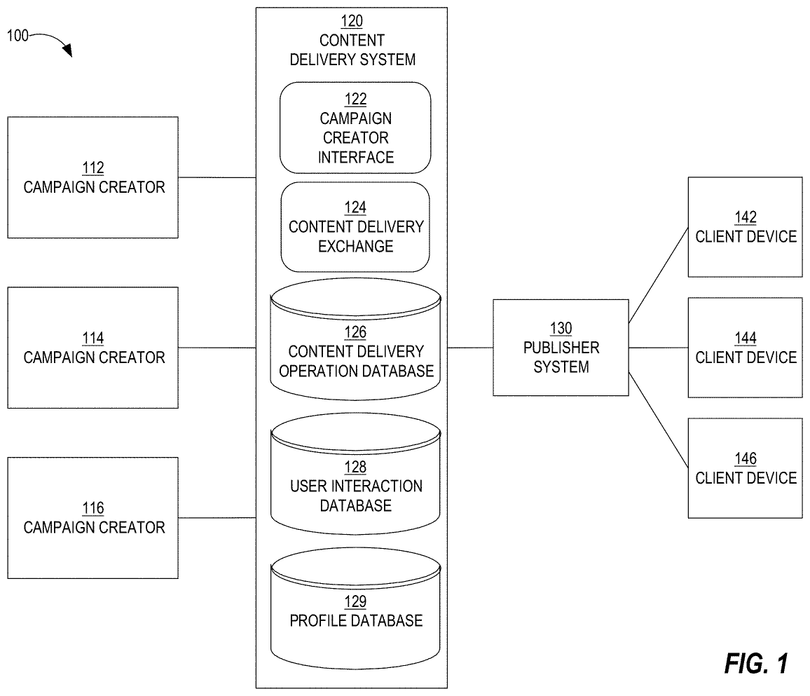

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery operations and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery operations and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Operations

Each content provider establishes a content delivery operation with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery operations within the account, and establish one or more attributes of each content delivery operation. Examples of operation attributes are described in detail below.

A content delivery operation includes (or is associated with) one or more content items. Thus, the same content item may be presented to users of client devices 142-146. Alternatively, a content delivery operation may be designed such that the same user is (or different users are) presented different content items from the same operation. For example, the content items of a content delivery operation may have a specific order, such that one content item is not presented to a user before another content item is presented to that user.

A content delivery operation is an organized way to present information to users that qualify for the operation. Different content providers have different purposes in establishing a content delivery operation. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery operation has a start date/time and, optionally, a defined end date/time. For example, a content delivery operation may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery operation. Thus, in this example, there is a definite (or “hard”) end date. As another example, a content delivery operation may have a “soft” end date, where the content delivery operation ends when the corresponding set of content items are displayed a certain number of times, when a certain number of users view, select, or click on the set of content items, when a certain number of users purchase a product/service associated with the content delivery operation or fill out a particular form on a website, or when a budget of the content delivery operation has been exhausted.

A content delivery operation may specify one or more targeting criteria that are used to determine whether to present a content item of the content delivery operation to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery operation may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery operation are not sent to the computing device.

Thus, content delivery exchange 124 is responsible for selecting a content delivery operation in response to a request from a remote computing device by comparing (1) targeting data associated with the computing device and/or a user of the computing device with (2) targeting criteria of one or more content delivery operations. Multiple content delivery operations may be identified in response to the request as being relevant to the user of the computing device. Content delivery exchange 124 may select a strict subset of the identified content delivery operations from which content items will be identified and presented to the user of the computing device.

Instead of one set of targeting criteria, a single content delivery operation may be associated with multiple sets of targeting criteria. For example, one set of targeting criteria may be used during one period of time of the content delivery operation and another set of targeting criteria may be used during another period of time of the operation. As another example, a content delivery operation may be associated with multiple content items, one of which may be associated with one set of targeting criteria and another one of which is associated with a different set of targeting criteria. Thus, while one content request from publisher system 130 may not satisfy targeting criteria of one content item of an operation, the same content request may satisfy targeting criteria of another content item of the operation.

Different content delivery operations that content delivery system 120 manages may have different charge models. For example, content delivery system 120 (or, rather, the entity that operates content delivery system 120) may charge a content provider of one content delivery operation for each presentation of a content item from the content delivery operation (referred to herein as cost per impression or CPM). Content delivery system 120 may charge a content provider of another content delivery operation for each time a user interacts with a content item from the content delivery operation, such as selecting or clicking on the content item (referred to herein as cost per click or CPC). Content delivery system 120 may charge a content provider of another content delivery operation for each time a user performs a particular action, such as purchasing a product or service, downloading a software application, or filling out a form (referred to herein as cost per action or CPA). Content delivery system 120 may manage only operations that are of the same type of charging model or may manage operations that are of any combination of the three types of charging models.

A content delivery operation may be associated with a resource budget that indicates how much the corresponding content provider is willing to be charged by content delivery system 120, such as $100 or $5,200. A content delivery operation may also be associated with a bid amount that indicates how much the corresponding content provider is willing to be charged for each impression, click, or other action. For example, a CPM operation may bid five cents for an impression, a CPC operation may bid five dollars for a click, and a CPA operation may bid five hundred dollars for a conversion (e.g., a purchase of a product or service).

Information about each content delivery operation, such as targeting criteria, start date, end date, original budget, current budget, active/inactive status, paused status, charge model, type of each content item associated with the content delivery operation, components of each content item, etc., may be stored in content delivery operation database 126, to which content delivery exchange 124 has access.

### Content Item Selection Events

As mentioned previously, a content item selection event is when multiple content items (e.g., from different content delivery operations) are considered and a subset selected for presentation on a computing device in response to a request. Thus, each content request that content delivery exchange 124 receives triggers a content item selection event.

For example, in response to receiving a content request, content delivery exchange 124 accesses content delivery operation database 126 to analyze multiple content delivery operations to determine whether attributes associated with the content request (e.g., attributes of a user that initiated the content request, attributes of a computing device operated by the user, current date/time) satisfy targeting criteria associated with each of the analyzed content delivery operations. If so, the content delivery operation is considered a candidate content delivery operation. One or more filtering criteria may be applied to a set of candidate content delivery operations to reduce the total number of candidates.

As another example, users are assigned to content delivery operations (or specific content items within operations) “off-line”; that is, before content delivery exchange 124 receives a content request that is initiated by the user. For example, when a content delivery operation is created based on input from a content provider, one or more computing components may compare the targeting criteria of the content delivery operation with attributes of many users to determine which users are to be targeted by the content delivery operation. If a user's attributes satisfy the targeting criteria of the content delivery operation, then the user is assigned to a target audience of the content delivery operation. Thus, an association between the user and the content delivery operation is made. Later, when a content request that is initiated by the user is received, all the content delivery operations that are associated with the user may be quickly identified, in order to avoid real-time (or on-the-fly) processing of the targeting criteria. Some of the identified operations may be further filtered based on, for example, the operation being deactivated or terminated, the device that the user is operating being of a different type (e.g., desktop) than the type of device targeted by the operation (e.g., mobile device).

A final set of candidate content delivery operations is ranked based on one or more criteria, such as predicted click-through rate (which may be relevant only for CPC operations), effective cost per impression (which may be relevant to CPC, CPM, and CPA operations), and/or bid price. Each content delivery operation may be associated with a bid price that represents how much the corresponding content provider is willing to pay (e.g., content delivery system 120) for having a content item of the operation presented to an end-user or selected by an end-user. Different content delivery operations may have different bid prices. Generally, content delivery operations associated with relatively higher bid prices will be selected for displaying their respective content items relative to content items of content delivery operations associated with relatively lower bid prices. Other factors may limit the effect of bid prices, such as objective measures of quality of the content items (e.g., actual click-through rate (CTR) and/or predicted CTR of each content item), budget pacing (which controls how fast a operation's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each operation in the final set of content delivery operations, an identity of an end-user to which the selected content item(s) will be presented, an indication of whether a content item from each operation was presented to the end-user, a predicted CTR of each operation, a CPC or CPM of each operation.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content items, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or an interaction data set. Thus, content delivery system 120 may include a user interaction database 128. Logging such events allows content delivery system 120 to track how well different content items and/or operations perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery operation (or multiple content items from the same content delivery operation), content delivery system 120 may calculate a user interaction rate for the content delivery operation. Additionally, from interaction data items and impression data items associated with a content provider (or content items from different content delivery operations initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

### Profile Database

Content delivery system 120 includes or is otherwise affiliated with profile database 129, which stores multiple entity profiles. Profile database 129 may be leveraged to identify, given one or more targeting criteria from a content provider, a target audience for a content delivery operation. Each entity profile in profile database 129 is provided by a different user. Example entities include users, groups of users, and organizations (e.g., companies, associations, government agencies, etc.). Each entity profile is provided by a different user or group/organization representative. An organization profile may include an organization name, a website, one or more phone numbers, one or more email addresses, one or more mailing addresses, a company size, a logo, one or more photos or images of the organization, an organization size, and a description of the history and/or mission of the organization. A user profile may include a first name, last name, an email address, residence information, a mailing address, a phone number, one or more educational/academic institutions attended, one or more academic degrees earned, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider).

Some data within a user's profile (e.g., job title, work history, skills) may be provided by the user while other data within the user's profile (e.g., endorsements, other skills) may be provided by a third party, such as a “friend,” connection, or colleague of the user.

Another computer system (not depicted) may prompt users to provide profile information in one of a number of ways. For example, that other system may have provided a web page with a text field for one or more of the above-referenced types of information. In response to receiving profile information from a user's device, the system stores the information in an account that is associated with the user and that is associated with credential data that is used to authenticate the user to the system when the user attempts to log into the system at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, the computer system stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by the computer system. For example, a user specifies, in his/her profile, a name of the user's employer. The computer system determines, based on the name, where the employer and/or user is located. If the employer has multiple offices, then a location of the user may be inferred based on an IP address associated with the user when the user registered with a social network service (e.g., provided by the computer system) and/or when the user last logged onto the social network service.

While many examples herein are in the context of online social networking, embodiments are not so limited. Embodiments are not limited to the type of data that profile database 129 stores or the type of requests that client devices 142-146 might submit.

### Content Item Request Processing

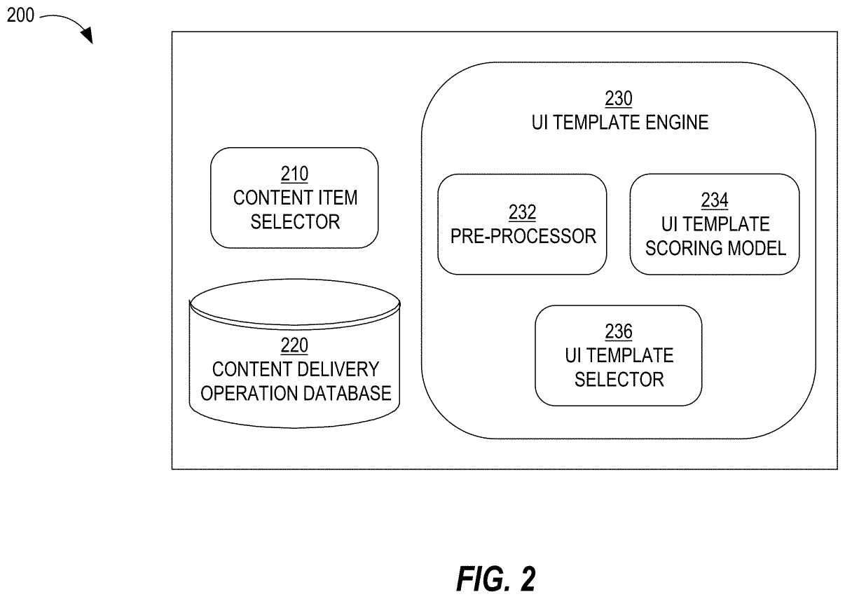

FIG. 2 is a block diagram that depicts an example system 200 that processes a content item request that is initiated by a client device, in an embodiment. System 200 corresponds to content delivery exchange 124 and includes a content item selector 210, content delivery operation database 220, and UI template engine 230.

Content item selector 210 leverages one or more models to select one or more content items in response to a content item request. A content item request may specify a number of content items, a range of numbers, or no numbers. A default number of content items to return may be one. A content item request may also include an entity identifier of the entity that operates the client device that triggered the content item request. A content item request may also include contextual data, such as a page type identifier that identifies a type of page that the entity requested (e.g., a user profile page, a company profile page, a news feed page, a product page), a contextual entity identifier that identifies an entity that is subject of the page (e.g., a user/member identifier, a company identifier), a time of day, a day of the week, a geographic location of the client device, a type of the client device (e.g., mobile device or desktop computer), a type of operating system executing on the client device, and a size of the screen of the client device.

Content item selector 210 accesses content delivery operation database 220 to identify multiple content delivery operations that target the entity (e.g., user) that initiated the content item request. Content item selector 210 generates a scoring instance for each operation, the scoring instance including feature values of the corresponding operation and feature values of the entity that initiated the content item request. The scoring instance may also include feature values pertaining to the context. Content item selector 210 inputs the scoring instance into one or more models (which may be rule-based models or machine-learned models, described in more detail herein), which produce a score for each scoring instance, which corresponds to a specific content delivery operation. Content item selector 210 selects a subset of the scored content delivery operations and one or more associated content items from each selected content delivery operation. The content item selector 210 sends the selected content item(s) (or their respective identifiers) to UI template engine 230.

UI template engine 230 considers many different UI templates for each selected content item. UI template engine 230 includes a pre-processor 232, a UI template scoring model 234, and a UI template selector 236. UI template scoring model 234 generates a score for each selected content item-UI template pair. Thus, if there are ten content items and one hundred UI templates, then UI template scoring model 234 generates one thousand scores, each corresponding to a different content item-UI template pair.

UI template selector 236 selects a UI template for each content item based on the scores associated with that content item. As described in more detail herein, given a set of selected content items, a different UI template may be selected for each selected content item, a single UI template may be selected for all selected content items, or a different UI template may be selected for different subsets of the set of selected content items.

### Rule-Based Model

Scoring content item-UI template pairs may be performed in a number of ways. For example, rules may be established that identify certain profile attributes and/or count certain activities of an entity and/or of entities that interacted with a UI template, each profile attribute and count corresponding to a different score and, based on a combination of all the scores, determine a score for a content item-UI template pair. For example, a click-through rate of 5% of a particular UI template may result in five points, users establishing one or more connections with employees at one or more companies after being presented with content items rendered according to the particular UI template may result in three points (bringing the total to eight points), and users sending multiple messages to those employees after being presented with content items rendered according to the particular UI template may result in ten points (bringing the total to eighteen points). If a user reaches twenty points, then it is predicted that the user will select the content item if it is rendered according to the corresponding UI template.

Rules may be determined manually by analyzing characteristics of users and content items that were rendered according to certain UI templates and with which were interacted by the users in the past. For example, it may be determined that 11% of users who were presented with content items according to four specific formatting attribute values selected the content items.

A rule-based model has numerous disadvantages, such as the failure to capture nonlinear correlations, the error-prone, bias inducing, and time consuming hand-selection of values (e.g., weights or coefficients), the output of a rule-based model being an unbounded positive or negative value. The output of a rule-based model does not intuitively map to the probability of a click, conversion, or other type of action for which the model is optimizing (e.g., predicting). In contrast, machine learning methods are probabilistic and therefore can give intuitive probability scores.

### Machine-Learned Model

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating or training a model. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

A machine-learned model may output different types of data or values, depending on the input features and the training data. For example, training data may comprise, for each content item, multiple feature values, each corresponding to a different feature. As described in more detail herein, example features of UI template scoring model include UI template features, user features, content item features, content provider features, contextual features. In order to generate the training data, information about each user-content item-content provider-context-UI template tuple is analyzed to compute the different feature values. In this example, the dependent variable of each training instance may be whether the user interacted with a content item. Example interactions include click, view for a minimum amount of time, like, share, comment, and conversion. Examples of conversions include filling out an electronic form, making a donation, electronically signing a petition, making a purchase, and attending an event. Source data that is used to generate the training data may originate from content delivery operation database 126, user interaction database 128, and, optionally, a content item selection database (not depicted) that includes information (if not already included in user interaction database 128) about content items and UI templates that were selected in past content item selection events.

Initially, the number of features that are considered for training may be significant. After training a machine-learned model and validating the model, an automated validator may determine that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features with little predictive power may be removed from the training data. Removing such features can speed up the process of training future models and computing output scores.

### Features of the UI Template Scoring Model

Example features of UI template scoring model 234 include UI template features and one or more of user features, content item features, content provider features, or contextual features. Example user features are features from a user profile, such as job title, industry, job function, seniority, academic degrees earned, past and current employers, past and current academic institutions attended, current job status, skills, and number of endorsements. Other user features may be derived based on online activities of a user, such as number of clicks on certain types of content items, number of visits to a social networking service in the last N days, number of job opportunities applied to, number of company pages visited, number of electronic messages transmitted to other users of the social networking service, etc. The user features of UI template scoring model 234 may be the same or similar to the user features of a content delivery operation scoring model that is used to select one or more content delivery operations.

Example content item features include subject matter of the content item, one or more targeting criteria (e.g., industry, job title), and key words found in the content item. Example content provider features include an identity of the content provider and an industry of the content provider. Example contextual features include a page type identifier that identifies a type of page that the entity requested, a contextual entity identifier that identifies an entity that is subject of the page, a time of day, a day of the week, a geographic location of the client device, a type of client device, a type of operating system executing on the client device, and a size of the screen of the client device. The content item features, content provider features, and contextual features of UI template scoring model 234 may be the same or similar to features of a content delivery operation scoring model that is used to select one or more content delivery operations.

Example UI template features includes features indicating whether certain content item components (described in more detail herein) are included, features indicating values for one or more of the content item components, and features indicating whether certain content item component orderings are part of the corresponding UI template. Each unique combination of values for the UI template features corresponds to a different UI template.

### Content Item Components

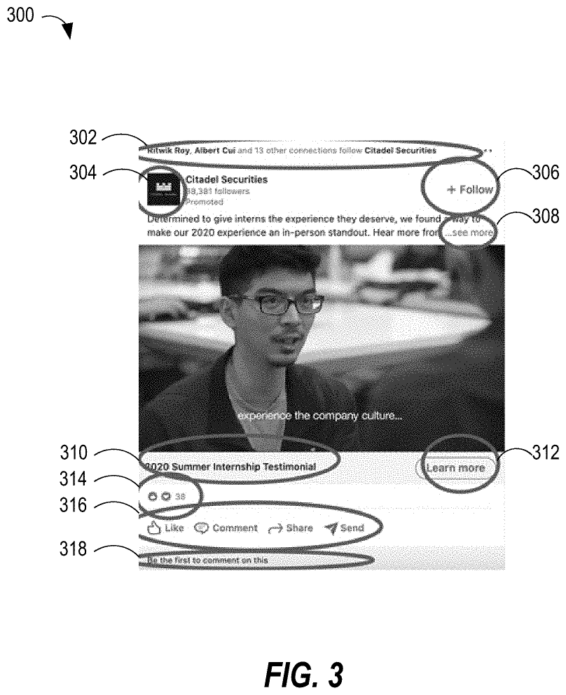

A content item comprises multiple components, examples of which are depicted in FIG. 3. Those example components of a content item include:
a. a social proof header 302 that indicates an identity and/or number of connections (of a user to which the content item is/will be presented) who like or follow the entity that is the subject of the content item,
b. a (e.g., company) logo 304 of that entity,
c. a follow button 306 that, if selected, causes the user to receive updates/content items pertaining to (or originating from) the entity,
d. a text “see more” button 308 that, if selected, causes additional text to be presented,
e. an article header 310 that provides a short title/description regarding the primary content of the content item,
f. an article CTA 312 (e.g., labeled “Learn More”) that, if selected, causes the corresponding article to be presented to the user,
g. a social proof counter 314 that indicates a number of interactions (e.g., likes, shares, comments) by other users of the content item,
h. a reaction bar 316 that allows the user to interact with (e.g., like, share, comment, or share) the content item, and
i. a comment section 318 that invites the user to create a comment that will be associated with the content item when it is presented to other users.

Different content items may include a different combination of these components. For example, one content item may include components 304, 308, 310, and 316, while another content item may include components 302, 304, 308, 314, and 316, while another content item may include components 302-318. Each UI template corresponds to a combination of content item components.

However, if there are more formatting attributes of a UI template, then some UI templates may correspond to the same combination of content item components. For example, one UI template selection feature may be a number of lines of text within a content item. Example values of this feature include 0, 1, 2, 3, and 4. Therefore, in this example, there would be at least five UI templates with the same combination of content item components but a different value for the text line feature. If there are twenty different combinations of content item components and five different values for the text line feature, then there are at least 20×5=100 different UI templates.

The text line feature/characteristic is one of multiple characteristics of content item components. Other example characteristics of content item components include:
a. font sizes and colors of text in social proof header 302,
b. sizes and positions of logo 304;
c. sizes, colors, and positions of follow button 306,
d. sizes, colors, and positions of button 308,
e. font sizes and colors of article header 310,
f. font sizes and colors of text within article CTA 312,
g. font sizes and colors of text within social proof counter 314 and sizes and colors of icons in social proof counter 314,
h. font sizes and colors of text in reaction bar 316 and color and sizes of icons in reaction bar 316, and
i. font sizes and colors of text in comment section 318 and a number of comments to include therein if multiple comments exist for the content item.

An administrator of content delivery system 120 or of content delivery exchange 124 may define possible values for each font size, each button size, each icon size, and each color of text, button, or other icon. For example, the possible values for font color may be black, dark blue, and gray; the possible values for font size may be any value within font size 5-10; the possible range of sizes for an icon may be 800 pixels to 1000 pixels, broken into 25 pixel increments; and the possible positions of a button or certain text may be left aligned, center, and right aligned.

Although the number of possible values for each component characteristic may be limited, the number of possible combinations of different values for these components characteristics may be very large. Add to that the number of different content item components and the number of possible UI templates is significant, such that it would be impractical to conduct an AB test to sufficiently test each possible UI template.

As described above, another type of feature for UI template scoring model 234 is component orderings. For example, if a first component and a second component are included in a content item, the first component may be included above the second component, below the second component, to the right of the second component, or to the left of the second component. However, a UI template's definition of component orderings must be consistent. For example, for any UI template, if component A is above component B and component B is above component C, component C cannot also be defined as above components A or B.

### Optimizing the UI Template Scoring Model

UI template scoring model 234 may be optimized on one of multiple metrics. Example metrics include click-through rate, conversion rate, and revenue. For example, the label of each training instance in training data that is used to train UI template scoring model 234 indicates whether the corresponding user selected (or “clicked” or viewed for a predetermined period of time) the corresponding content item. Again, each training instance corresponds to a particular UI template.

As another example, the label of each training instance is an amount of revenue that content delivery system 120 earned as a result of presenting the corresponding content item. The amount of revenue may be limited to the revenue earned (if any) from presenting the corresponding content item, or an amount of revenue earned in a period of time that began with the presentation of the corresponding content item and that ended a certain time later (e.g., two minutes or as defined by the corresponding user's session). Revenue may be a valuable metric on which to optimize because some UI templates cause the corresponding content item to take up more space on a computer screen, which means less content items will be displayed, all else being equal.

### Pre-Filtering UI Templates

In an embodiment, one or more UI templates are filtered from consideration prior to UI template scoring model 234 generating a set of scores for a content item. Thus, some UI templates will not be scored, at least for one content item. Such “filtering” may be performed by pre-processor 232.

One way to automatically filter UI templates is through a set of consistency rules. A consistency rule may be an internal consistency rule or an external consistency rule. An internal consistency rule is one that ensures that the visual characteristics (e.g., color scheme, formatting attributes) of a UI template are consistent with each other. For example, if one component button has blue text, then all component buttons should have blue text. As another example, if one component text has font size of 6, then all other component text should have font size of 6, or no larger than font size of 6.

An internal consistency rule may be applied prior to any content item requests are received. In other words, pre-processor 232 may apply internal consistency rules not in response to a content item request. In an embodiment, given a set of all possible UI templates, pre-processor 232 applies internal consistency rules to that set and filters out any UI templates that violate an internal consistency rule.

An external consistency rule is one that ensures that the visual characteristics of a UI template are consistent with the surrounding design paradigm, the page on which the corresponding content item will be presented, and/or the content item itself. For example, if a website is using a limited number of text fonts, then pre-processor 232 determines the identity of those text fonts and filters out all UI templates that have a text font that is different than the identified text fonts. As another example, if a web page is using a certain color scheme to present certain UI elements, then pre-processor 232 determines the colors in that color scheme and filters out all UI templates that have colors that are not part of the color scheme. As another example, if the image of a content item has a lot of blue hues or has text in a certain font embedded in the image, then the pre-processor 232 filters out all UI templates that have colors that are not consistent with the blue hues or have text in a different font than the embedded text. A score will not be generated for a “filtered out” UI template.

Pre-processor 232 may apply one or more external consistency rules in response to a content item request or may apply one or more external consistency rules not in response to content item requests. For example, for external consistency rules related to an entire website, pre-processor 232 applies those external consistency rules to identify a subset of possible UI templates. Then, when content delivery system 120 receives a content item request, UI template engine 230 does not consider any UI templates outside that subset when generating a set of scores given a selected content item. As another example, for external consistency rules related to a page on which a selected content item is to be presented, in response to receiving a content item request, pre-processor 232 applies external consistency rules that pertain to that page to identify a subset of possible UI templates.

In an embodiment, pre-processor 232 applies one or more first external consistency rules prior to receiving content item requests to identify a subset of possible UI templates and then applies one or more second external consistency rules to the subset in response to receiving the content item requests to identify a subset of the subset. Thus, the second external consistency rules do not have to applied to possible UI templates that were filtered out after the first external consistency rules were applied.

In an embodiment, UI templates are filtered based on performance metrics. In this embodiment, the filtering of UI templates is data driven. For example, an observed/actual click through rate (CTR) of content items rendered according to a UI template is calculated. This may be repeated for each possible UI template. To calculate an observed CTR of a UI template, user interaction database 128 may be analyzed to identify (1) a number of impression data items that pertain to the UI template and (2) a number of interaction data items that pertain to the UI template. The value of (2) divided by (1) is computed to determine the observed CTR of the UI template. If the observed CTR of a UI template is below a particular threshold, then the UI template may be removed from consideration and will not be scored for subsequent selected content items, at least for a period of time.

As a related example, at any given point in time, the top N UI templates in terms of performance metrics may be selected for scoring, where N is a positive integer, such as 100 or 398. Thus, over time, a different set of N UI templates may be selected based on their respective performance metrics.

In an embodiment, pre-processor 232 considers accessibility requirements in determining which UI templates to filter. For example, a user may be associated with a certain minimize font size, such that anything smaller than that minimum font size, the user is unable to read the corresponding text. Thus, when the user triggers a content item request, content delivery system 120 identifies the user and pre-processor 232 determines that the user is associated with (e.g., in the user's profile in profile database 126) a minimum font size. As another example, a user might be using a screen reader to read a content item feed. A screen reader is a software program that allows blind or visually impaired users to read text that is displayed on a computer screen. Pre-processor 232 determines this situation and filters out UI templates that would make it difficult for users with screen readers to read the text.

### Post-Scoring UI Template Selection

After UI template engine 230 uses UI template scoring model 234 to generate multiple scores for a selected content item, one score for each UI template, UI template selector 236 selects one of the UI templates corresponding to one of the scores. For example, if one hundred UI templates were scored for a content item, then UI template selector 236 selects one of the one hundred UI templates based on the scores.

UI template selector 236 may use one or more selection criteria in selecting a UI template for a content item based on a set of scores generated by UI template scoring model 234 for the content item. One example selection criterion is selecting the UI template with the highest score. Another selection criterion is removing UI templates that are associated with scores that are below a certain threshold. Then, for the remaining UI templates, generate a random number between a certain range (e.g., corresponding to the number of remaining UI templates) and use the random number to select one of those remaining UI templates. Thus, all remaining UI templates have an equal chance of being selected. In a related selection criterion, the scores are used to generate a weighted die, which is used to generate a random number to select one of the UI templates. Thus, the higher the score, the more likely the corresponding UI template will be selected. However, in this example scenario, all scored UI templates have a chance at being selected.

As different UI templates are selected and used to render different content items, user interaction history may be analyzed to determine how well the UI templates have performed. Based on this user interaction history, statistics may be generated for each UI template may be generated. One example statistic is an error bar that reflects an amount of information received so far for the corresponding UI template and how confident that the system is in the score generated for the corresponding UI template or that the system is less confident about the statistic of the corresponding UI template. Conversely, a narrow error bar indicates that there is a relatively large amount of information about the corresponding UI template. In an embodiment, UI template selector 236 takes into account one or more statistics for each scored UI template and adjusts the corresponding score and then, after adjusting multiple scores, selects the UI template with the highest score. The adjustment of a score for a UI template may involve selecting a random adjustment value within a range of adjustment values (e.g., a negative value to a positive value), where the range is based on user interaction history for the UI template. Thus, different UI templates may be associated with different ranges. The range of adjustment values may be modeled as a normal distribution, meaning that the likelihood that a value at one the ends of the range is selected is relatively low. By adjusting scores in this way, UI template selector 236 might select a UI template that is associated with a relative low score, especially when there is little information known about the performance of content items that have been rendered according to the UI template.

### Contextual Bandits

There are other techniques to adjust scores generated by UI scoring model 234. In an embodiment, UI template selector 236 implements a contextual bandits algorithm to choose a UI template based on those scores. Such an algorithm is derived based on the multi-arm bandit problem, which, in probability theory and machine learning, is a problem in which a fixed limited set of resources must be allocated between competing (alternative) choices in a way that maximizes their expected gain, when each choice's properties are only partially known at the time of allocation and may become better understood as time passes or by allocating resources to the choice. This is a reinforcement learning problem that exemplifies the exploration—exploitation tradeoff dilemma.

The name of this problem comes from imagining a gambler, at a row of slot machines (known as “one-armed bandits”), who must decide which machines to play, how many times to play each machine and in which order to play them, and whether to continue with the current machine or try a different machine. In the problem, each machine provides a random reward from a probability distribution specific to that machine. The objective of the gambler is to maximize the sum of rewards earned through a sequence of lever pulls. The crucial tradeoff the gambler faces at each trial is between “exploitation” of the machine that has the highest expected payoff and “exploration” to get more information about the expected payoffs of the other machines.

A variation of the bandits problem is the contextual bandits problem, where, in each iteration, an agent has to choose between arms. Before making the choice, the agent sees a d-dimensional feature vector (context vector) that is associated with the current iteration. The learner uses these context vectors along with the rewards of the arms played in the past to make the choice of the arm to play in the current iteration. Over time, the learner's aim is to collect enough information about how the context vectors and rewards relate to each other, so that it can predict the next best arm to play by looking at the context vectors.

### Content Item Feed

A content item feed is a set of content items that is presented on a screen of a computing device. A content item feed (or simply “feed”) includes user interface controls for scrolling through the feed. A user interface control for receiving user input to scroll through a feed is referred to as a scroll element or “thumb.” Content items within a feed may be scrolled up and down or side to side. A feed may have a limited number of content items or may be an “infinite” feed where, as the feed is being scrolled through (whether automatically or in response to user input), additional content items (that have not yet been presented in the feed) are presented.

A content item feed contains multiple types of content items. One type of content item (referred to herein as the “first type”) is one that has been created by one of content providers 112-116 and that is associated with a content delivery operation having targeting criteria that are used to identify the user or client device that is presenting the content item.

Another type of content item (referred to herein as the “second type”) is content that is generated based on activity of users in an online network of the user that is viewing the content item. Examples of such a content item include a content item identifying an article authored by a friend or connection of the user in the online network, a content item identifying an article interacted with (e.g., selected, viewed, commented, liked, shared) by such a friend or connection, a content item identifying a change in a status of such a friend, a content item identifying news pertaining to an organization (e.g., company, academic institution, community organization) with which the user is associated or affiliated, or of which the user a member (e.g., as specified in the user's online social network). Such content items originate from content delivery system 120 and/or publisher system 130.

Another type of content item (referred to herein as the “third type”) is a content item indicating a type of content in which content delivery system 120 (or an affiliated system) predicts the user might be interested. Examples of types of recommended content include people (i.e., potential friends/connections), jobs, and video courses. Such content items do not originate from content providers 112-116 and are not part of a content delivery operation. However, the source of the jobs and the authors/providers of the video courses may be third-party entities relative to content delivery system 120 and/or publisher system 130.

In an embodiment, one or more additional machine-learned models are trained for content items of another type, such as content items of the second type and content items of the third type. Users tend to interact differently to content items of different types. Therefore, a first machine-learned model that has been trained for content items of the first type may have different objectives/labels (e.g., revenue v. user interaction/engagement) and different features (e.g., different contextual features) than a second machine-learned model that has been trained for content items of another type.

In a related embodiment, multiple UI template scoring models are invoked in response to the same content item request. One UI template scoring model is used to score content items of a first type that may be presented on a page and another UI template scoring model is used to score content items of a second type that may be presented on the same page.

### UI Template Consistency

There are at least two types of UI template consistency: page consistency and cross-page consistency. UI template consistency may be enforced by UI template selector 236. An example of page consistency is using the same UI template (or similar UI templates) for multiple content items on the same page, such as in the same content item feed. Instead of appearing in the same content item feed, the multiple content items may appear on another part of the page, such as on the top side and the right side of the page. An example of cross-page consistency is using the same UI template (or similar UI templates) for content items that are presented to the same user on different pages. This is described in more detail herein.

Regarding page consistency, one or more rules may be applied to ensure page consistency across multiple content items. Such rule application may be performed by UI template selector 236. Without one or more page consistency rules, it is possible that each content item that is presented in a single content item feed (or on a single page) will be rendered according to an inconsistent UI template. This may be undesirable for aesthetic purposes.

One page consistency rule is that each content item (at least of a particular type, such as sponsored content items) is to be rendered according to the same UI template. Therefore, after a set of scores is generated for each content item in a set of multiple content items (resulting in multiple sets of scores), UI template selector 236 may select a single UI template to render all of the content items. Such a selection may be performed by (a) examining all the scores in all the sets of scores or (b), after selecting a UI template for each content item of the multiple content items based on the set of scores corresponding to that content item, examining the selected UI templates (or their respective scores).

As an example of (a), UI template selector 236 averages (or determines the median of) the scores for each UI template and selects the UI template with the highest average/median score to render all of the content items (e.g., in the content item feed).

As an example of (b), UI template selector 236 selects a UI template for each content item (e.g., using contextual bandits or taking the top score) and then considers the selected UI templates. If UI template selector 236 selected the same UI template for each content item, then that UI template is used to render all of the content items. If not, then if one UI template was selected multiple times (or more than other UI templates) for the multiple content items, then that UI template is used to render all of the content items. If there was no UI template that was selected more than others, then UI template selector 236 may choose one that is associated with the highest score, or highest adjusted score. In a related example, if a UI template was selected for one of the multiple content items, but that UI template is associated with a score that is lower than a particular threshold for another one of the multiple content items, then that UI template is removed from consideration. Thus, UI template selector 236 may perform some filtering of candidate UI templates before selecting one UI template to render all of the content items (e.g., in the same content item feed).

As described above, cross-page consistency is another type of UI consistency and is applicable to content item feeds and to single content item situations. Changing the rendering of content items for a user on a regular (e.g., daily) basis may be undesirable. Thus, in an embodiment, the number of UI templates that are used to present multiple content items over a certain period of time may be limited. There are at least two of cross-page consistency: session-based and time-based. One example rule is that any particular user is limited to viewing content items according to one UI template during (a) that user's session with publisher system 130 or (b) any particular day.

Therefore, when selecting a UI template to render one or more content items, UI template selector 236 first determines whether another UI template has already been selected for the user (a) in the same session as the current session or (b) in a previous session, but the same day/week/etc. This determination may involve retrieving UI template selection data that was generated previously for the user. If the determination results in the negative, then UI template selector 236 select a UI template according to one of the described approaches herein and stores UI template selection data (that identifies the selected UI template) in association with the user or the session. Conversely, if the determination results in the positive, then UI template selector 236 determines the UI template that is indicated in the UI template selection data and that UI template is used to render the one or more content items.

In an embodiment, UI template consistency does not require the same UI template for multiple content items on the same page or across pages that are presented to a user. UI template consistency may include consistency of one or more visual characteristics (or visual elements) across different content items, such as text color, border color, button color, text font size, button size, individual component dimensions, and overall content item dimensions. For example, different UI templates may be used to render different content items in the same content item feed as long as the different UI templates indicate the same text color, the same text font size, and the same button size. As another example, different UI templates may be used to render different content items in the same user session as along as the different UI templates indicate the same components and the same component dimensions.

Additionally or alternatively to hard rules that can be prescribed manually, in some embodiments, consistency is required in a “soft” way by incorporating inconsistency penalties into the objective that a machine-learned-based template optimization engine is trying to optimize. The term “soft” indicates that such objective function penalization allows an ML model to decide when to obey consistency and when to be slightly inconsistent. For example, monetization metrics (e.g., CTR or CPC) may be improved sufficiently to trade off against small/negligible impacts to engagement metrics that come from inconsistency between sponsored content presentation and organic content presentation. In the ML field, such penalization techniques are referred to as “regularization” or “multi-objective optimization.” Such “soft” consistency may be used in combination with obeying “hard” rules, which may be referred to as “guardrails.” For example, a ML model may have leeway to drop some engagement metric by up to 0.5% but never beyond that, and its own objective seeks only to drop engagement at levels below or approaching the 0.5% mark to the extent to which it improves other metrics in return. There are many different algorithms that admit such penalties and the specific instantiation has more to do with the loss function being specified than the algorithm being used to minimize the loss. A computer system that combines hard and soft consistency in this way is likely to perform better than one that does not so combine. The computer system that combines both types of consistency improves metrics by a larger amount while still guaranteeing that the computer system will safely operate within guardrail bounds (and is likely to be more consistent on average than computer systems that do not combine both types of consistency).

### Example Process

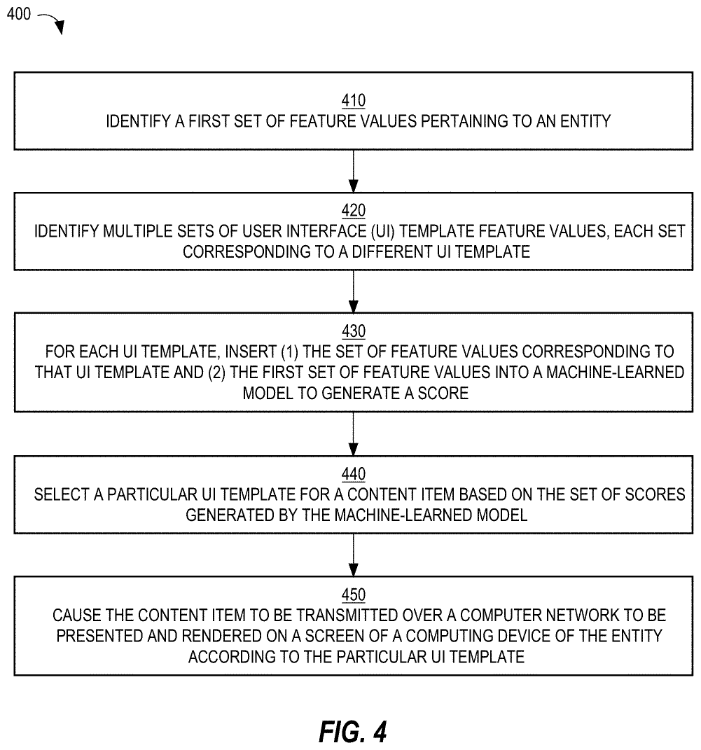

FIG. 4 is a flow diagram that depicts an example process 400 for rendering one or more content items, in an embodiment. Process 400 may be performed by different components or elements of content delivery system 120.

At block 410, a first set of feature values pertaining to an entity/user is identified. Block 410 may be performed in response to receiving, at content delivery system 120, a content item request from a computing device of the entity. The content item request may include an identifier that is used to retrieve a profile of the entity, which profile might contain one or more of the features values in the first set.

At block 420, multiple sets of UI template feature values are identified, each set pertaining to a different UI template. Block 420 may be performed after a content item has been selected for presentation, for example, in response to the content item request.

At block 430, for each UI template, (1) the set of feature values corresponding to that UI template and (2) the first set of feature values (pertaining to the entity) are inserted or inputted into a machine-learned model to generate a score, which is added to a set of scores that is initially empty until the score for the first UI template is generated.

At block 440, a particular UI template for a content item is selected based on the set of scores. For example, the highest score is selected. As another example, each score in the set is adjusted based on one or more criteria and then the highest adjusted score is selected.

At block 450, the content item is transmitted over a computer network to be presented and rendered on a screen of a computing device of the entity according to the particular UI template.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

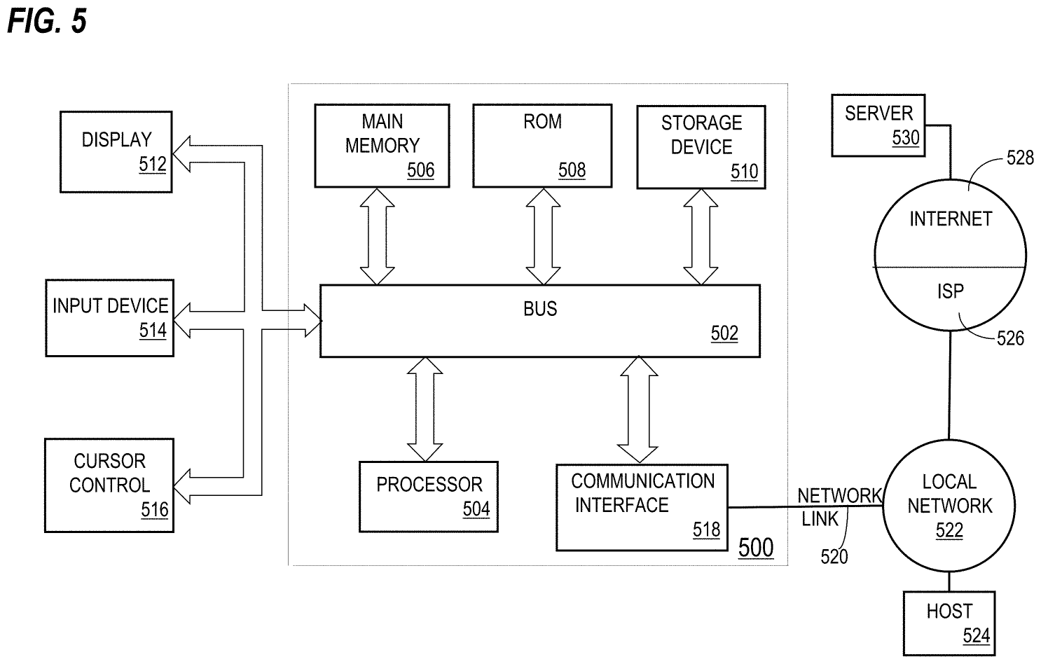

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a first set of feature values pertaining to a first entity;
identifying a plurality of sets of feature values, each set of feature values pertaining to a different user interface (UI) template for rendering content items on a computer screen;
for each set of feature values of the plurality of sets of feature values:
inserting said each set of feature values and the first set of feature values into a machine-learned model to generate a score;
adding the score to a set of scores;
selecting, based on the set of scores, a particular UI template for a content item;
causing the content item to be transmitted over a computer network to be presented on a screen of a computing device of the first entity according to the particular UI template;
wherein the method is performed by one or more computing devices.

2. The method of claim 1, wherein features of the machine-learned model include one or more of:
first features indicating whether certain content item components are included in content items;
second features corresponding to values for one or more of the certain content item components; or
third features indicating whether certain content item component orderings are part of a corresponding UI template.

3. The method of claim 2, wherein the features include the first features or the second features, wherein the certain content item components include two or more of:
a social proof header, a logo, a follow button, a see more button, an article header, an article call-to-action, a social proof counter, a reaction bar, or a comment section.

4. The method of claim 3, wherein:
the features also include the third features;
the third features include (1) a first feature that indicates a first component ordering and (2) a second feature that indicates a second component ordering that is different than the first component ordering.

5. The method of claim 1, wherein features of the machine-learned model include two or more of:
a page type identifier that identifies a type of page that a user requested,
a contextual entity identifier that identifies an entity that is subject of the page,
a time of day,
a day of the week,
a geographic location of a client device on which the content item will be presented,
a type of client device,
a type of operating system executing on the client device, or
a size of the screen of the client device.

6. The method of claim 1, further comprising:
storing user interaction data that indicates interactions by users of content items;
storing UI template data that indicates, for each impression of a plurality of impressions of the content items, a UI template that was used to render a content item that corresponds to said each impression;
generating, based on the user interaction data and the UI template data, training data that comprises a plurality of training instances, each of which includes a label that indicates whether a corresponding user interacted with a corresponding content item;
using one or more machine learning techniques to train the machine-learned model based on the training data.

7. The method of claim 1, wherein each score in the set of scores corresponds to a different UI template of a plurality of UI templates, wherein the plurality of UI templates is a strict subset of a set of UI templates, the method further comprising:
storing one or more consistency rules;
applying the one or more consistency rules to the set of UI templates to identify the plurality of UI templates.

8. The method of claim 7, wherein the one or more consistency rules includes an external consistency rule that ensures that formatting attributes of each candidate UI template that is to be scored are consistent with (a) visual characteristics of a website that hosts the content item or (b) a page on which the content item will be presented.

9. The method of claim 7, wherein the one or more consistency rules includes an internal consistency rule that ensures that formatting attributes of a candidate UI template are consistent with formatting attributes of each other candidate UI template.

10. The method of claim 1, wherein each score in the set of scores corresponds to a different UI template of a plurality of UI templates, wherein the plurality of UI templates is a strict subset of a set of UI templates, the method further comprising:
identifying a performance metric of each UI template in the set of UI templates;
based on the performance metric of each UI template in the set of UI templates, filtering the set of UI templates to determine the plurality of UI templates.

11. The method of claim 1, further comprising:
in response to receiving a content item request:
identifying a plurality of content items, that includes the content item, to present on the screen of the computing device;
ensuring visual consistency of the plurality of content items by (a) using the particular UI template to render each content item of the plurality of content items or (b) using one or more other UI templates that share one or more visual characteristics in common with the particular UI template to render the plurality of content items other than the content item.

12. The method of claim 1, wherein the content item is a first content item that is transmitted in response to a first content item request, the method further comprising:
in response to receiving a second content item request that was initiated by the first entity:
identifying a second content item that is different than the first content item;
determining that the particular UI template was used previously for the first entity;
in response to determining that the particular UI template was used previously for the first entity, ensuring visual consistency of the second content item and the first content item by (a) using the particular UI template to render the second content item or (b) using one or more other UI templates that share one or more visual characteristics in common with the particular UI template to render the second content item.

13. One or more storage media storing instructions which, when executed by one or more processors, cause:
identifying a first set of feature values pertaining to a first entity;
identifying a plurality of sets of feature values, each set of feature values pertaining to a different user interface (UI) template for rendering content items on a computer screen;
for each set of feature values of the plurality of sets of feature values:
inserting said each set of feature values and the first set of feature values into a machine-learned model to generate a score;
adding the score to a set of scores;
selecting, based on the set of scores, a particular UI template for a content item;
causing the content item to be transmitted over a computer network to be presented on a screen of a computing device of the first entity according to the particular UI template.

14. The one or more storage media of claim 13, wherein features of the machine-learned model include one or more of:
first features indicating whether certain content item components are included in content items;
second features corresponding to values for one or more of the certain content item components; or
third features indicating whether certain content item component orderings are part of a corresponding UI template.

15. The one or more storage media of claim 14, wherein the features include the first features or the second features, wherein the certain content item components include two or more of:
a social proof header, a logo, a follow button, a see more button, an article header, an article call-to-action, a social proof counter, a reaction bar, or a comment section.

16. The one or more storage media of claim 13, wherein the instructions, when executed by the one or more processors, further cause:
storing user interaction data that indicates interactions by users of content items;
storing UI template data that indicates, for each impression of a plurality of impressions of the content items, a UI template that was used to render a content item that corresponds to said each impression;
generating, based on the user interaction data and the UI template data, training data that comprises a plurality of training instances, each of which includes a label that indicates whether a corresponding user interacted with a corresponding content item;
using one or more machine learning techniques to train the machine-learned model based on the training data.

17. The one or more storage media of claim 13, wherein each score in the set of scores corresponds to a different UI template of a plurality of UI templates, wherein the plurality of UI templates is a strict subset of a set of UI templates, wherein the instructions, when executed by the one or more processors, further cause:
storing one or more consistency rules;
applying the one or more consistency rules to the set of UI templates to identify the plurality of UI templates.

18. The one or more storage media of claim 13, wherein each score in the set of scores corresponds to a different UI template of a plurality of UI templates, wherein the plurality of UI templates is a strict subset of a set of UI templates, wherein the instructions, when executed by the one or more processors, further cause:
identifying a performance metric of each UI template in the set of UI templates;
based on the performance metric of each UI template in the set of UI templates, filtering the set of UI templates to determine the plurality of UI templates.

19. The one or more storage media of claim 13, wherein the instructions, when executed by the one or more processors, further cause:
in response to receiving a content item request:
identifying a plurality of content items, that includes the content item, to present on the screen of the computing device;
ensuring visual consistency of the plurality of content items by (a) using the particular UI template to render each content item of the plurality of content items or (b) using one or more other UI templates that share one or more visual characteristics in common with the particular UI template to render the plurality of content items other than the content item.

20. The one or more storage media of claim 13, wherein the content item is a first content item that is transmitted in response to a first content item request, wherein the instructions, when executed by the one or more processors, further cause:
in response to receiving a second content item request that was initiated by the first entity:
identifying a second content item that is different than the first content item;
determining that the particular UI template was used previously for the first entity;
in response to determining that the particular UI template was used previously for the first entity, ensuring visual consistency of the second content item and the first content item by (a) using the particular UI template to render the second content item or (b) using one or more other UI templates that share one or more visual characteristics in common with the particular UI template to render the second content item.
